(19) United States
(12) Patent Application Publication
(10) Pub. No.: US 2012/0081901 A1
(43) Pub. Date: Apr. 5, 2012

(54) ILLUMINATION DEVICE WITH LIGHT EMITTING DIODE

(75) Inventor: JIAN-SHIHN TSANG, Tu-Cheng (TW)

(73) Assignee: HON HAI PRECISION INDUSTRY CO., LTD., Tu-Cheng (TW)

(21) Appl. No.: 12/949,822

(22) Filed: Nov. 19, 2010

(30) Foreign Application Priority Data
Sep. 30, 2010 (TW) 99133184

(51) Int. Cl. F21V 17/02

(52) U.S. Cl. 362/277

(57) ABSTRACT

An illumination device includes an LED light source, a fluorescent board, and an intensity controller. The LED light source emits first wavelength light. The fluorescent board is located on the light path of the first wavelength light emitted from the LED light source. The fluorescent board absorbs a portion of the first wavelength light emitted from the LED light source and emits second wavelength light. The intensity controller is located on the light path of the light exiting from the fluorescent board, and decreases the intensity of the first wavelength light.

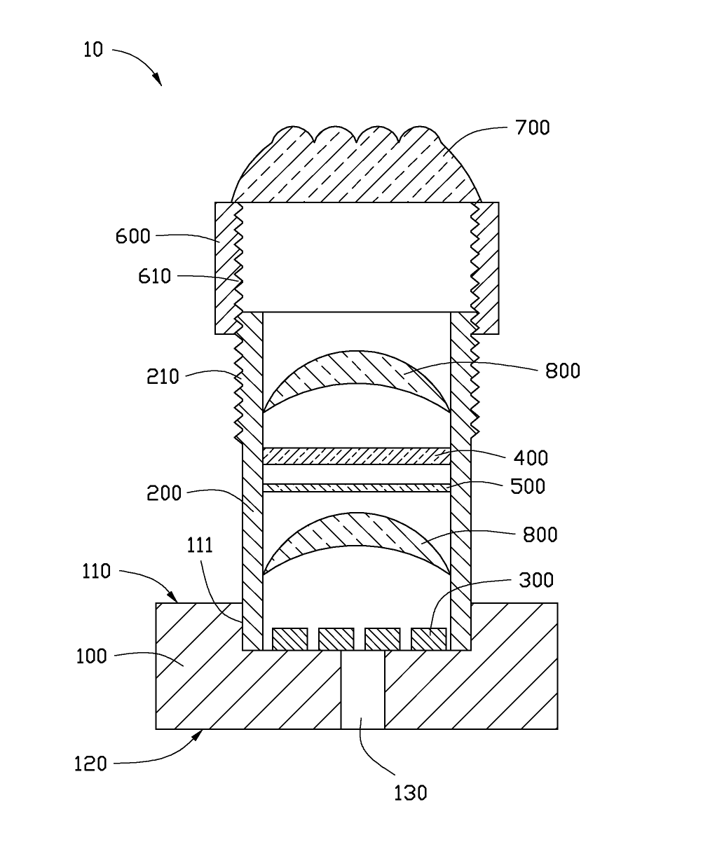

### BACKGROUND

1. Technical Field

The present disclosure relates to illumination device and, particularly, to a illumination device with light emitting diodes.

2. Description of Related Art

The technology of light emitting diode (LED) has been rapidly developed in recent years from indicators to illumination applications. With the features of long-term reliability, environment friendliness and low power consumption, the LED is viewed as a promising alternative for future lighting products. Normally, the LED used for illumination is white LED. The white LED usually includes an excitation light source and at least one type fluorescent powder. However, the fluorescent powder in the white LED is usually distributed unevenly, and the color temperature excursion of the white LED would be too great to satisfy customer's requirement. As a result, the white LED with too great color temperature excursion would be discarded as useless.

What is needed is an illumination device which can ameliorate the problem of the prior art.

### BRIEF DESCRIPTION OF THE DRAWINGS

Many aspects of the present illumination device can be better understood with reference to the accompanying drawings. The components in the drawings are not necessarily drawn to scale, the emphasis instead being placed upon clearly illustrating the principle of the illumination device. In the drawings, all the views are schematic.

The only drawing is a schematic, cross-sectional view of an illumination device according to an exemplary embodiment.

### DETAILED DESCRIPTION

Embodiments of the present disclosure will now be described in detail below, with reference to the accompanying drawing.

Referring to the only drawing, an illumination device 10 according to an exemplary embodiment is shown. The illumination device 10 includes a lamp holder 100, a stationary barrel 200, an LED light source 300, an intensity controller 400, a fluorescent board 500, a movable barrel 600, a first lens 700, and two second lenses 800.

The lamp holder 100 is configured for supporting the stationary barrel 200 and the LED light source 300. In the present embodiment, the lamp holder 100 includes a first surface 110 and a second surface 120 opposite to the first surface 110. A receiving groove 111 is defined on the first surface 110, and is configured for receiving the LED light source 300. The lamp holder 100 further defines a through hole 130 passing through the second surface 120 and the first surface 110 defining the receiving groove 111, and the LED light source 300 can be electrically connected to an external power source (not shown) via electrical wires (not shown) extending through the through hole 130.

The stationary barrel 200 has a first end received in the receiving groove 111 of the lamp holder 100 and a second end away from the lamp holder 100. The LED light source 300 is received in the first end of the stationary barrel 200. The intensity controller 400, the fluorescent board 500, and the second lenses 800 are fixedly received in the stationary barrel 200. The intensity controller 400 and the fluorescent board 500 are located between the two second lenses 800. In the present embodiment, the second end of the stationary barrel 200 has an outer screw thread 210.

The LED light source 300 includes a plurality of LED chips. The LED light source 300 can emit a first wavelength light. In the present embodiment, the first wavelength light is blue light.

The fluorescent board 500 is located on the light path of the first wavelength light emitted from the LED light source 300. The fluorescent board 500 has fluorescent powder dispersed therein or thereon. The fluorescent board 500 can absorb a portion of the first wavelength light emitted from the LED light source 300 and emit second wavelength light. The fluorescent board 500 can be made of silicon, epoxy resin, or glass etc. with fluorescent powder dispersed therein or thereon. The fluorescent powder can be yellow fluorescent powder, or red and green fluorescent powder etc.

The intensity controller 400 is located on the light path of the light exiting from the fluorescent board 500. The intensity controller 400 is configured for decreasing the intensity of the first wavelength light; therefore, the color temperature of light emitted out of the illumination device 10 can be adjusted. The intensity controller 400 can be a first wavelength light filter, a first wavelength light attenuator, or a first wavelength light absorber etc. In the present embodiment, the LED light source 300 is blue light source, the fluorescent powder dispersed in or on the fluorescent board 500 is yellow fluorescent powder, and the intensity controller 400 is a blue light filter.

The movable barrel 600 has an inner screw thread 610 engaging with the outer screw thread 210, and the movable barrel 600 can move along an axial direction of the stationary barrel 200 by rotating the movable barrel 600. It is understood, the engagement between the movable barrel 600 and the stationary barrel 200 is not limited to the present embodiment; in other embodiments, the movable barrel 600 can also be engaged with the stationary barrel 200 and movable therealong by using other mechanisms.

The first lens 700 is located at an end of the movable barrel 600 away from the LED light source 300. The distance between the second lenses 800 and the first lens 700 can be adjusted by rotating the movable barrel 600, and the light emitting angle of the illumination device 10 can be changed correspondingly. In the present embodiment, the outer surface of the first lens 700 has a number of protrusions thereon. These protrusions can uniform the light emitted from the first lens 700. In order to further improve the uniformity of the light emitted from the first lens 700, the outer surface of the first lens 700 can be roughed, or the first lens 700 can be doped with diffusing particles.

In the present embodiment, one of the second lenses 800 is located between the fluorescent board 500 and the LED light source 300, and the other second lens 800 is located between the intensity controller 400 and the first lens 700.

While certain embodiments have been described and exemplified above, various other embodiments will be apparent to those skilled in the art from the foregoing disclosure. The disclosure is not limited to the particular embodiments described and exemplified, and the embodiments are capable of considerable variation and modification without departure from the scope and spirit of the appended claims.

What is claimed is:

1. An illumination device comprising:
an LED light source emitting first wavelength light;
a fluorescent board located on the light path of the first wavelength light emitted from the LED light source, the fluorescent board absorbing a portion of the first wavelength light emitted from the LED light source and emitting second wavelength light; and
an intensity controller located on the light path of the light emitted from the fluorescent board, and decreasing the intensity of the first wavelength light.

2. The illumination device as claimed in claim 1, wherein the intensity controller is a first wavelength light filter, a first wavelength light attenuator, or a first wavelength light absorber.

3. The illumination device as claimed in claim 1, wherein the first wavelength light is blue light.

4. The illumination device as claimed in claim 3, wherein the intensity controller is a blue light filter, a blue light attenuator, or a blue light absorber.

5. The illumination device as claimed in claim 1 further comprising a lamp holder and a stationary barrel, the lamp holder defines a receiving groove therein for receiving the LED light source, the stationary barrel has an end received in the receiving groove and has the LED light source received therein, the intensity controller and the fluorescent board are fixedly received in the stationary barrel.

6. The illumination device as claimed in claim 5 further comprising a movable barrel engaging with an end of the stationary barrel away from the lamp holder, and the movable barrel is movable along an axial direction of the stationary barrel.

7. The illumination device as claimed in claim 6 further comprising a first lens fixed to the movable barrel.

8. The illumination device as claimed in claim 7 further comprising at least one second lens fixed in the stationary barrel.

9. The illumination device as claimed in claim 7, wherein the first lens comprises a plurality of protrusions on a surface thereof away from the LED light source.

10. The illumination device as claimed in claim 7, wherein a surface of the first lens away from the LED light source is roughed.

11. The illumination device as claimed in claim 7, wherein the first lens is doped with diffusing particles.

12. The illumination device as claimed in claim 7 further comprising two second lenses fixed in the stationary barrel, wherein one of the second lenses is located between the fluorescent board and the LED light source, and the other second lens is located between the intensity controller and the first lens.
